(19) United States
(12) Patent Application Publication
(10) Pub. No.: US 2022/0049482 A1
(43) Pub. Date: Feb. 17, 2022

(54) VALVE DEVICE

(71) Applicant: BETTIOL S.R.L., Chioggia (VE) (IT)

(72) Inventor: Davide BETTIOL, Chioggia (VE) (IT)

(73) Assignee: BETTIOL S.R.L., Chioggia (VE) (IT)

(21) Appl. No.: 17/435,756

(22) PCT Filed: Mar. 5, 2020
(86) PCT No.: PCT/IB2020/051910

§ 371 Date: Sep. 2, 2021

(30) Foreign Application Priority Data
Mar. 5, 2019 (IT) 102019000003171

(51) Int. Cl. E03C 1/298; E03F 5/04; E03C 1/292; E03F 5/042; F16K 15/14

(52) U.S. Cl. CPC E03C 1/298; E03F 5/0405; E03F 2005/0417; E03F 5/042; F16K 15/147; E03C 1/292

(57) ABSTRACT

A valve device includes:
a hollow member having a through-hole with an axis, an internal surface delimiting the through-hole, a peripheral surface delimiting the hollow member's transverse extent with respect to the axis, and at least one deformation zone deformable to reduce the transverse extent when compression forces act on the peripheral surface, the deformation of the deformation zone moving the hollow member from a rest to a use state, and
at least one closure portion extending radially from the hollow member inside the through-hole up to a respective free edge, in contact with the internal surface of the hollow member and/or with at least one free edge of another closure portion occluding the through-hole when in use. The at least one closure portion includes a flexible membrane, foldable when subjected to a fluid and/or solid pressure which moves in the through-hole along the axis, thereby defining a passage.

### TECHNICAL FIELD

The present invention relates to a valve device, a water trap and a pipe for discharging waste water comprising such a valve device.

### TECHNOLOGICAL BACKGROUND

The present invention is used particularly, though not exclusively, in the technical sector relating to devices which are suitable for preventing the passage of unpleasant odours in urban drainage systems and/or tubes for discharging waste water, in particular for discharging untreated water from domestic uses or condensate water produced by conditioners.

An example of a device which can be installed in discharge tubes for waste water is described in US 2013/0117921 A1.

With regard to urban drainage systems, it is known to produce bell-like traps which are intended to be used in drainage tanks. With reference to FIG. 1, the bell-like trap is provided with a funnel-like opening and an inverted frustoconical receptacle which is intended to contain a quantity of fluid which is introduced through the funnel-like opening. The water contained by the receptacle forms a hydraulic cap which blocks the passage of unpleasant odours from the tank to the external environment. However, the Applicant has found that this solution may be affected by a number of disadvantages: for example, the bell-like trap can readily become obstructed as a result of the leaves which can fall inside the receptacle through the grate which closes the tank at the upper side.

With regard to the discharge tubes for waste water, the trap is typically produced by a U-shaped tube portion which defines a bend which is intended to retain a quantity of water which is capable of occluding the tube, thereby blocking the rise of unpleasant odours from the sewage network. However, the residual water present in the stagnation zone of the trap is subjected to evaporation, particularly in the case of prolonged non-use of the apparatuses joined to the pipe of the trap, a fact which can lead to a failure to block the fumes from the sewage network of the pipe and therefore to the dispersion thereof in the spaces in which the above-mentioned apparatuses are arranged. Furthermore, the quantity of water which defines the hydraulic cap can be subjected to freezing when the corresponding trap is arranged in particularly cold environments. This may bring about the blockage or breakage of the trap itself.

### STATEMENT OF INVENTION

An object of the present invention is to provide a valve device, a water trap comprising such a valve device and a pipe for discharging waste water comprising such a valve device which is structurally and functionally configured to overcome at least one limitation which is set out above with reference to the known solutions. This objective is achieved by means of a valve device, a water trap and a pipe for discharging waste water in accordance with the respective independent claims appended to the present description.

Preferred features of the invention are defined in the dependent claims.

In the context of the present invention, the expression “deformation zone” indicates at least a portion of a hollow member of the valve device, the shape of which is capable of varying (in a temporary or permanent manner) as a result of external forces which are applied to such a hollow member.

In the context of the present invention, the expression “flexible membrane” indicates an element which has a small thickness and which is capable of being adapted with substantial ease to a curvilinear configuration or an angle when it is subjected to pressure of a fluid and/or solid.

In the context of the present invention, the expression “waste water” indicates untreated water which is produced by domestic, industrial or agricultural uses or condensate water which is produced by conditioners, heaters or more generally by thermal environmental conditioning plants.

According to an aspect of the invention, the valve device comprises a hollow member. The hollow member comprises a through-hole having an axis X, an internal surface which delimits the through-hole and a peripheral surface which delimits the transverse extent of the hollow member with respect to the axis X.

The valve device comprises at least one deformation zone which is capable of being deformed, in particular compressed, so as to reduce the transverse extent of the hollow member when one or more compression forces act on the peripheral surface. The deformation, in particular compression, of the at least one deformation zone moves the hollow member from a rest state to a state for use.

In other words, the at least one deformation zone is provided in such a manner that the transverse extent of the hollow member is reduced when one or more compression forces act on the peripheral surface.

The transverse extent of the hollow member is therefore greater in the rest state with respect to the extent in the state for use.

The valve device further comprises at least one closure portion which extends radially from the hollow member inside the through-hole up to a respective free edge, which is substantially in contact with the internal surface of the hollow member and/or with at least one free edge of another closure portion of the valve device so as to occlude the through-hole when the hollow member is in the state for use.

According to an aspect of the invention, the at least one closure portion comprises a flexible membrane (in particular it is a flexible membrane) which is capable of folding when it is subjected to a pressure of a fluid and/or solid which moves in the through-hole along the axis X (in particular, in accordance with a first direction), thereby defining a passage which allows the fluid and/or solid to pass through the through-hole.

These features advantageously allow the construction of a valve device which can be installed in water traps and/or pipes for discharging waste water in order to block possible gas from rising in these water traps/pipes, at the same time allowing the passage of fluids and/or solids.

By way of example, the pipes for discharging waste water can be identified by the discharge pipes of washbasins, showers, bidets, washing machines, dishwashers, water-closet, conditioners or heaters.

The valve device according to the invention allows the use of traps to be avoided.

Preferably, the transverse extent of the hollow member with respect to the axis X corresponds to the extent of the hollow member perpendicular to this axis.

Preferably, the through-hole extends longitudinally along the axis X.

Preferably, the peripheral surface corresponds to a lateral surface of the hollow member which extends along the axis X.

Preferably, the compression force is a pressing force on the peripheral surface.

Preferably, the compression force is a radial force.

Preferably, the compression force has a direction which is incident to the peripheral surface and which is directed in the direction of the interior of the hollow member.

Preferably, each deformation zone is deformed, in particular compressed, when the hollow member is in the state for use.

Preferably, the flexible membrane is capable of bending by moving the relevant free edge towards the internal surface of the hollow member.

Preferably, each closure portion of the valve device comprises a respective flexible membrane.

According to an aspect of the invention, the at least one deformation zone is made of deformable material. Preferably, the at least one deformation zone is made of resiliently deformable material, more preferably from polymer material, more preferably silicone and even more preferably elastomer silicone. According to an aspect of the invention, the flexible membrane of the at least one closure portion is made of deformable material, preferably of resiliently deformable material, more preferably from polymer material, more preferably silicone and even more preferably elastomer silicone.

Preferably, the flexible membrane of the at least one closure portion has a thickness between 1 mm and 6 mm, more preferably between 2 mm and 4.5 mm. Preferably, the above-mentioned flexible membrane has a thickness which is progressively reduced in a direction which extends from the hollow member towards the respective free edge. By way of example, this thickness is reduced from approximately 4.5 mm to approximately 2 mm.

According to an aspect of the invention, the flexible membrane of the at least one closure portion is subjected to resilient deformation, in particular reversible resilient deformation, when the pressure applied to the relevant closure portion is greater than or equal to 50 Pa, in particular is between 50 and 1500 Pa (Pascal).

Preferably, the flexible membrane of the at least one closure portion is subjected to resilient deformation, in particular reversible resilient deformation, when the pressure applied by a fluid and/or solid, which moves in the through-hole in the axis X, to the relevant closure portion is greater than or equal to 50 Pa, in particular is between 50 and 1500 Pa, thereby defining a passage which allows the fluid and/or solid to pass through the through-hole.

Preferably, the flexible membrane of the at least one closure portion is not subjected to deformation when the pressure applied to the relevant closure portion is less than 50 Pa.

Preferably, the deformable material has an elasticity modulus between 1 Mpa and 5 Mpa, more preferably between 1.5 Mpa and 3 Mpa according to the standard ASTM D412 DIE C, where ASTM is the acronym for American Society for Testing and Materials International.

More preferably, the deformable material has an elasticity modulus of 2.6 Mpa according to the standard ASTM D412 DIE C.

Preferably, the deformable material has a traction breaking load (“tensile strength”) between 5 Mpa and 12 Mpa according to the standard ASTM D412 DIE C, more preferably in the range [7.5-10.5] Mpa according to the standard ASTM D412 DIE C.

According to an aspect of the invention, the deformable material comprises silicone material. Preferably, the deformable material is silicone rubber or another silicone elastomer material.

The main advantages of the silicone material are optimum chemical inertia and thermal stability, and good properties of electrical insulation.

According to an aspect of the invention, the at least one deformation zone corresponds to a recess of the hollow member. Preferably, this recess has a longitudinal extent in accordance with the axis X.

Preferably, the recess delimits a respective indentation of the hollow member, the width of which is at a maximum when the respective deformation zone is not subjected to compression.

When a deformation zone is compressed, in particular in a direction tangential to the peripheral surface near this zone, two mutually opposite portions of the hollow member which delimit the recess are subjected to mutual movement together, preferably until coming into contact with each other, thereby reducing or eliminating the width of the indentation. The movement together of the above-mentioned portions therefore produces a reduction of the transverse extent of the hollow member.

According to an aspect of the invention, the at least one deformation zone is delimited by a respective concavity of the peripheral surface, this concavity having a longitudinal extent in accordance with the axis X.

Alternatively, the at least one deformation zone may correspond to a respective projection of the hollow member. Preferably, this projection has a longitudinal extent in accordance with the axis X. Preferably, the projection delimits a respective convexity of the hollow member, the width of which is at a maximum when the respective deformation zone is not subjected to compression. In this case, the at least one deformation zone is therefore delimited by a respective convexity of the peripheral surface, this convexity having a longitudinal extent in accordance with the axis X.

In other words, according to an embodiment of the invention, the at least one deformation zone may correspond to a recess of the hollow member (the recess preferably having a longitudinal extent in accordance with the axis X) or a projection of the hollow member (the projection preferably having a longitudinal extent in accordance with the axis X).

According to an aspect of the invention, the at least one deformation zone has a U-shape. In this case, the U-shape is flattened following the compression of the respective deformation zone.

According to an aspect of the invention, the deformation zone comprises at least one portion of the peripheral surface and/or at least one portion of the above-mentioned internal surface.

According to an aspect of the invention, the hollow member has a continuous profile, that is to say, the profile is not provided with interruptions.

Conversely, the hollow member may have an interruption along a cross-section thereof, for example, it may have a C-like cross-section.

In other words, according to an embodiment of the invention, the hollow member has a C-shaped cross-section.

This provision allows deformation of the at least one deformation zone so as to overlap the free ends of the C-shape of the hollow member when one or more compression forces act on the peripheral surface, thereby reducing the transverse extent of the hollow member.

According to an aspect of the invention, the free edge of the at least one closure portion comprises an edging which extends substantially along the axis X when the hollow member is in the state for use. In particular, the edging is substantially in contact with the internal surface of the hollow member and/or with at least one edging of another closure portion so as to occlude the through-hole when the hollow member is in the state for use.

This provision allows the through-hole to be kept closed in the case of inverse pressures, that is to say, pressures having a direction counter to the first direction mentioned above, acting on the at least one closure portion.

Preferably, the edging and the at least one closure portion, or more generally the valve device, are configured to withstand counter-pressures up to 1 bar, that is to say, they are configured to keep the through-hole closed for counter-pressures up to 1 bar which act on the at least one closure portion.

In this manner, the valve device according to the invention acts as an anti-reflux valve, blocking possible occurrences of fluids rising.

Alternatively or additionally, the free edge of the at least one closure portion is flared.

According to an aspect of the invention, the internal surface of the hollow member is provided with an abutment, against which the at least one closure portion is intended to move into abutment when the hollow member is in the state for use.

According to an aspect of the invention, the hollow member has a profile which is substantially circular, that is to say, it is circular apart from the at least one deformation zone in the form of a recess. However, the profile of the hollow member may have different shapes, such as, for example, elliptical or polygonal shapes.

In the embodiment of the invention in which the hollow member has a substantially circular profile, the variation (in particular reduction) of the transverse extent of the hollow member coincides with the variation (in particular reduction) of the external diameter thereof. The external diameter is delimited by the peripheral surface of the valve device.

Preferably, the hollow member comprises or is constituted by a cylindrical wall with a circular, elliptical or polygonal base. Preferably, the cylindrical wall comprises the internal surface and the peripheral surface opposite the internal surface and the at least one deformation zone.

Alternatively, the hollow member may have an annular shape.

According to an aspect of the invention, the valve device comprises a plurality of closure portions. Preferably, each closure portion has a circular sector shape and extends between a deformation zone and the subsequent deformation zone.

This feature allows both a reduction in the transverse extent of the hollow member and a simplified fold of the one or more flexible membranes.

According to an aspect of the invention, the hollow member and the at least one closure portion are produced from a single piece of deformable material, preferably from resiliently deformable material, more preferably from silicone material (for example, silicone rubber).

According to an aspect of the invention, the hollow member extends along the axis X from a first end to a second end, the at least one closure portion extending from the first end towards the second end, particularly when the respective free end is substantially in contact with the internal surface of the hollow member and/or with at least one free edge of another closure portion.

Preferably, the valve device comprises a plurality of closure portions which extend so as to converge from the first end towards the second end.

Therefore, the closure portions form a conical surface of the valve device when the free edges are substantially in contact with each other so as to occlude the through-hole. This promotes the folding of the one or more flexible membranes in order to define the passage for the flow of the fluid and/or solid when the fluid and/or solid move(s) from the first end to the second end of the hollow member.

According to an aspect of the invention, the valve device comprises a belt having a transverse extent less than that of the hollow member when it is in the rest state so as to press the hollow member by means of the contact between an internal face of the belt and the peripheral surface of the hollow member when it is inserted in the belt, placing and maintaining the hollow member in the state for use.

Preferably, the belt has a substantially circular profile, the internal diameter of which is less than the external diameter of the hollow member, which itself has a substantially circular profile.

The belt may be an annular clamp which is preferably flat.

Preferably, the belt is made of plastics material or metal material.

According to an aspect of the invention, the peripheral surface of the hollow member has an upper peripheral projection and, preferably, a lower peripheral projection. The internal face of the belt may have a channel which is formed so as to receive in an engaging manner the upper peripheral projection of the hollow member. Preferably, the lower peripheral projection is intended to abut a lower edge of the belt when the hollow member is inserted in the belt itself. These characteristics allow a stable connection to be promoted between the hollow member and the belt.

According to an aspect of the invention, the water trap comprises a box-shaped tank which comprises a base and a plurality of side walls which delimit a cavity in communication with an opening of the tank opposite the base.

The water trap further comprises the valve device according to the invention and a support which is capable of fixing the valve device to the tank by blocking it inside the cavity. The support and the valve device together subdivide the cavity into two chambers, one under the other.

Therefore, the valve device is positioned inside the cavity so as to subdivide it into two above-mentioned chambers.

The water trap comprises a cover above the valve device for closing the opening of the tank.

Preferably, the support has an inverted frustoconical shape and is provided, at an upper end thereof, with a peripheral end piece which is intended to move into abutment with an edge of the tank which delimits the opening thereof. The support terminates in an opening which is delimited by a surface which is suitable for pressing the hollow member by means of the contact with the peripheral surface thereof (or with an external surface of the belt), placing and maintaining the hollow member in the state for use.

In other words, the opening of the support defines a seat which has dimensions for receiving in an engaging manner the valve device (with or without the belt).

According to an aspect of the invention, the pipe for discharging waste water comprises a tube which is suitable for being passed through by a fluid. The pipe further comprises the valve device according to the invention, which is positioned inside the tube.

The tube has a transverse extent less than that of the hollow member of the valve device when the hollow member is in the rest state so as to press the hollow member by means of the contact between an internal surface of the tube and the peripheral surface of the hollow member, placing and maintaining the hollow member in the state for use.

In other words, the tube has a cavity which defines a seat which has dimensions for receiving in an engaging manner the valve device (with or without the belt).

### BRIEF DESCRIPTION OF THE DRAWINGS

Features and advantages of the invention will be better appreciated from the following detailed description of preferred embodiments thereof which are illustrated by way of non-limiting example with reference to the appended Figures, in which:

FIG. 1 shows an embodiment of a tank with a trap according to the prior art,

FIG. 2 is a schematic illustration of a valve device according to the invention,

FIGS. 3 and 4 are a plan view and a perspective bottom view of the valve device of FIG. 2, respectively,

FIG. 5 is a cross-section of the valve device of FIG. 1 in a different operating condition,

FIGS. 6 and 7 are schematic views of a valve device according to the invention provided with a belt,

FIG. 8 is a schematic illustration of an additional embodiment of a valve device according to the invention,

FIG. 9 is a schematic illustration of an additional embodiment of a valve device according to the invention,

FIG. 10 is a cross-section of the valve device of FIG. 9,

FIG. 11 is a perspective sectional view of a water trap according to the invention,

FIGS. 12 and 13 are a cross-sectional plan view and front view of the water trap of FIG. 11, respectively, and

FIG. 14 is a cross-section of a pipe for discharging waste water according to the invention.

### DESCRIPTION OF EMBODIMENTS OF THE INVENTION

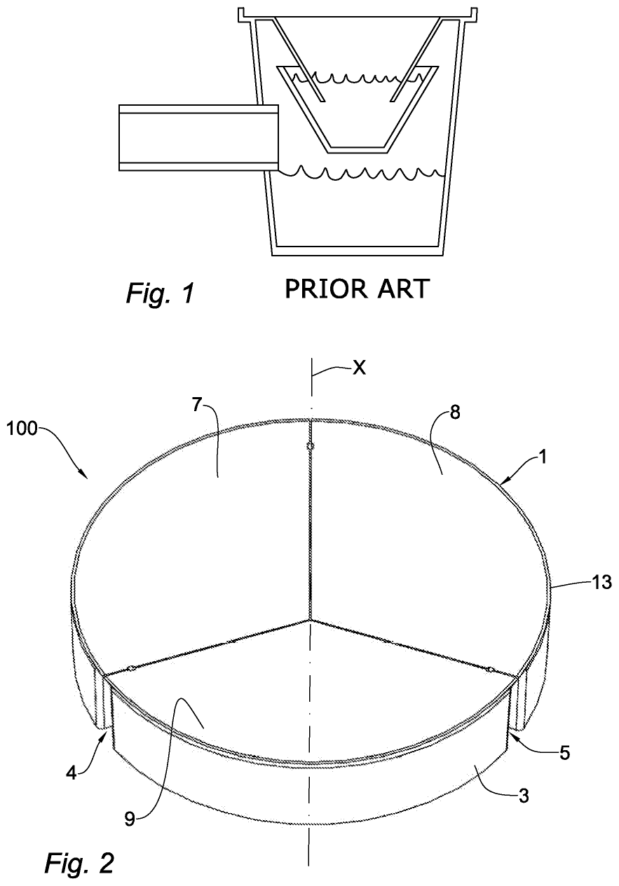

FIG. 1 shows an embodiment of the tank provided with a trap constructed according to the prior art.

With reference to FIG. 2, a valve device according to the present invention is generally designated 100.

The valve device 100 comprises a hollow member 1 which comprises a through-hole 2 having an axis X, an internal surface 2a which delimits the through-hole 2, a peripheral surface 3 which delimits the transverse extent of the hollow member with respect to the axis X and three deformation zones 4, 5 and 6 which are made of resiliently deformable material.

The deformation zones 4, 5 and 6 are suitable for being compressed so as to reduce the transverse extent of the hollow member 1 when one or more compression forces act on the peripheral surface 3. The compression of the deformation zones 4, 5 and 6 moves the hollow member 1 from a rest state to a state for use.

The deformation zones 4, 5 and 6 of the hollow member 1 correspond to respective recesses of the hollow member 1. In particular, the deformation zones 4, 5 and 6 are delimited by respective concavities of the peripheral surface 3, those concavities having a longitudinal extent in accordance with the axis X.

The valve device 100 further comprises three closure portions 7, 8 and 9 which extend radially from the hollow member 1 inside the through-hole 2 up to respective free edges 10, 11 and 12 which are substantially in contact with each other so as to occlude the through-hole 2 when the hollow member 1 is in the state for use.

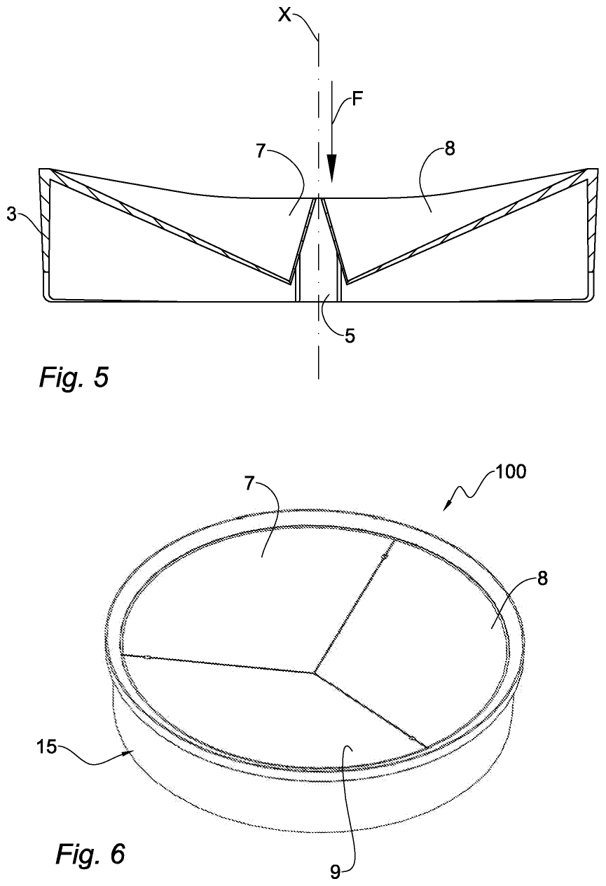

Each closure portion 7, 8 and 9 is a flexible membrane which is suitable for being bent when it is subjected to a pressure of a fluid and/or solid which moves in the through-hole 2 along the axis X and in accordance with a first direction (indicated by the arrow F in FIG. 5), thereby defining a passage which allows the fluid and/or solid to pass through the through-hole 2.

With reference to the Figures, in particular FIG. 4, the hollow member 1 has a continuous and substantially circular profile. The closure portions 7, 8 and 9 are constructed in the form of circular sectors, each circular sector extending between a deformation zone and the subsequent deformation zone.

In particular, the hollow member 1 is a cylindrical wall and the peripheral surface 3 delimits the external diameter of the hollow member 1. The external diameter of the hollow member 1 has a greater extent in the rest state than in the state for use.

The hollow member 1 and the closure portions 7, 8 and 9 are formed from a single piece of resiliently deformable material, for example, silicone material.

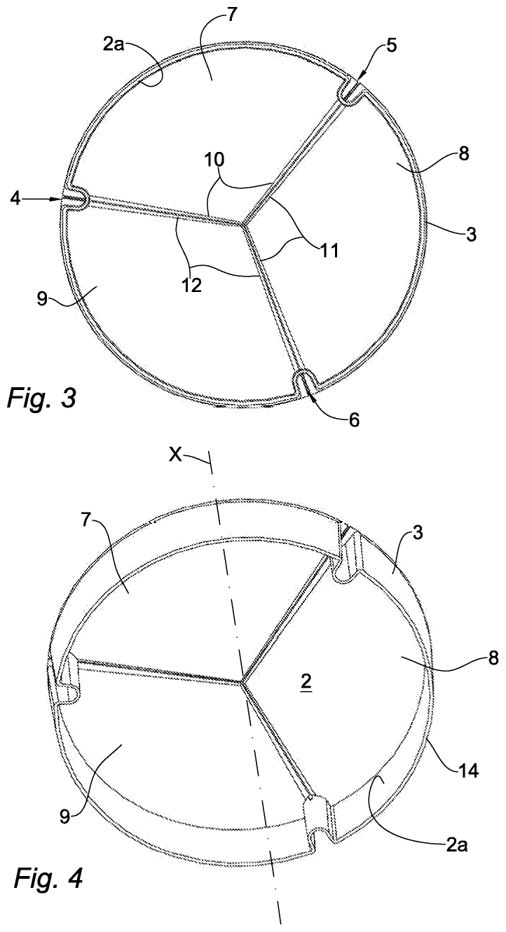

With reference to FIGS. 2 to 4, the hollow member 1 extends along the axis X from a first end 13 to a second end 14, the closure portions 7, 8 and 9 extending from the first end 13 so as to converge towards the second end 14.

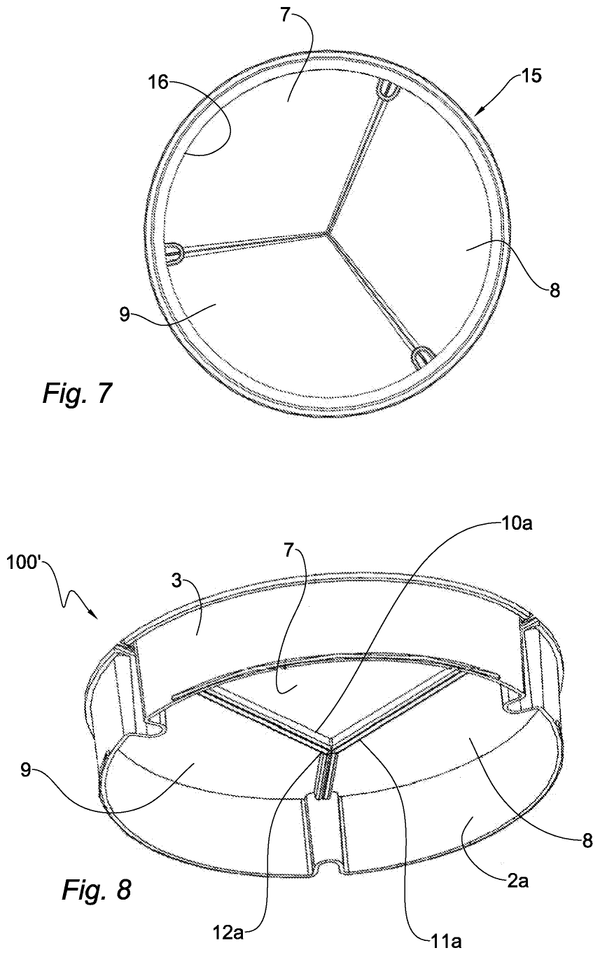

With reference to FIGS. 6 and 7, the device 100 comprises a belt 15 having a transverse extent less than that of the hollow member 1 when it is in the rest state so as to press the hollow member 1 by means of the contact between an internal face 16 of the belt 15 and the peripheral surface 3 of the hollow member 1 when it is inserted in the belt 15, placing and maintaining the hollow member 1 in the state for use. In particular, the internal diameter of the belt 15 is less than the external diameter of the hollow member 1 when it is in the rest state.

FIG. 8 shows another embodiment of the valve device according to the invention. The valve device, which is generally designated 100′, comprises a plurality of edgings 10a, 11a and 12a. In particular, the free edges 10, 11 and 12 of the closure portions 7, 8, 9 each comprise an edging 10a, 11a and 12a which extend substantially along the axis X when the hollow member 1 is in the state for use.

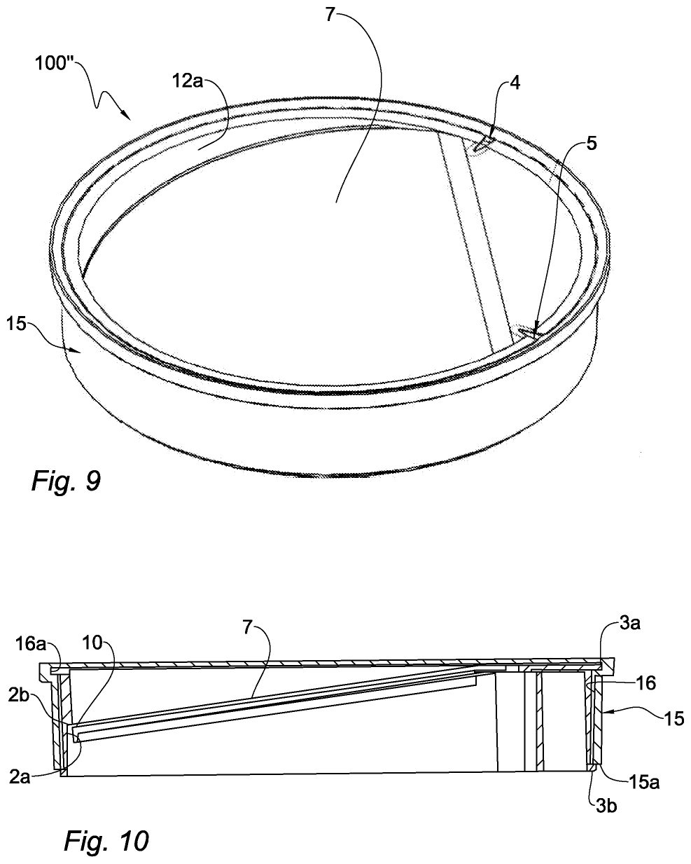

With reference to FIGS. 9 and 10, a valve device according to the present invention is generally designated 100″. This valve device 100″ differs from the one shown in the preceding Figures in that it has a single closure portion 7. The closure portion 7, in particular the free edge 10 of this closure portion 7, is substantially in contact with the internal surface 2a of the hollow member 1. The internal surface 2a of the hollow member 1 is provided with an abutment 2b, with which the closure portion 7 is intended to move into abutment when the hollow member 1 is in the state for use.

The peripheral surface 3 of the hollow member 1 has an upper peripheral projection 3a and a lower peripheral projection 3b while the internal face 16 of the belt 15 has a groove 16a which is formed so as to receive in an engaging manner the upper peripheral projection 3a mentioned above. The lower peripheral projection 3b abuts a lower edge 15a of the belt 15 when the hollow member 1 is inserted in the belt 15.

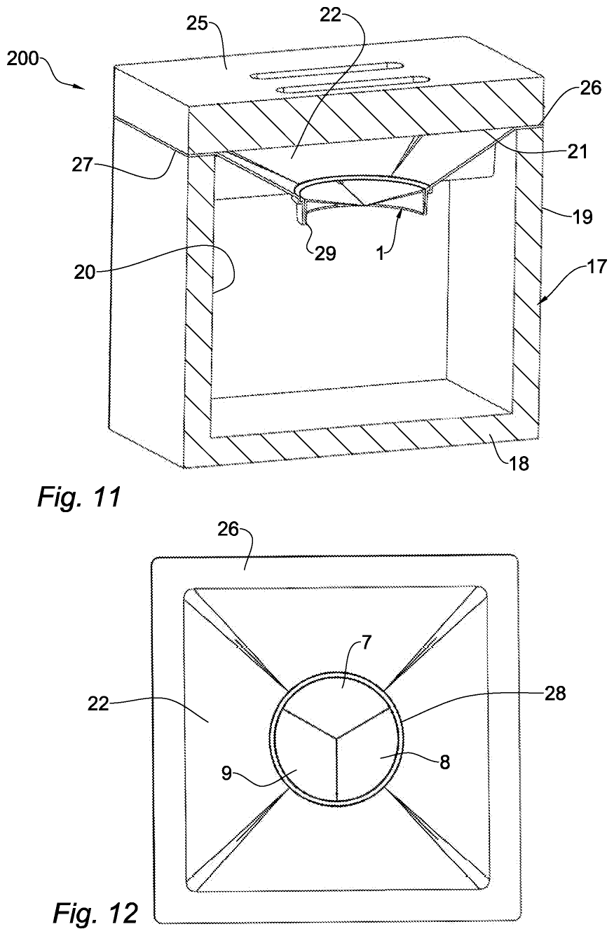

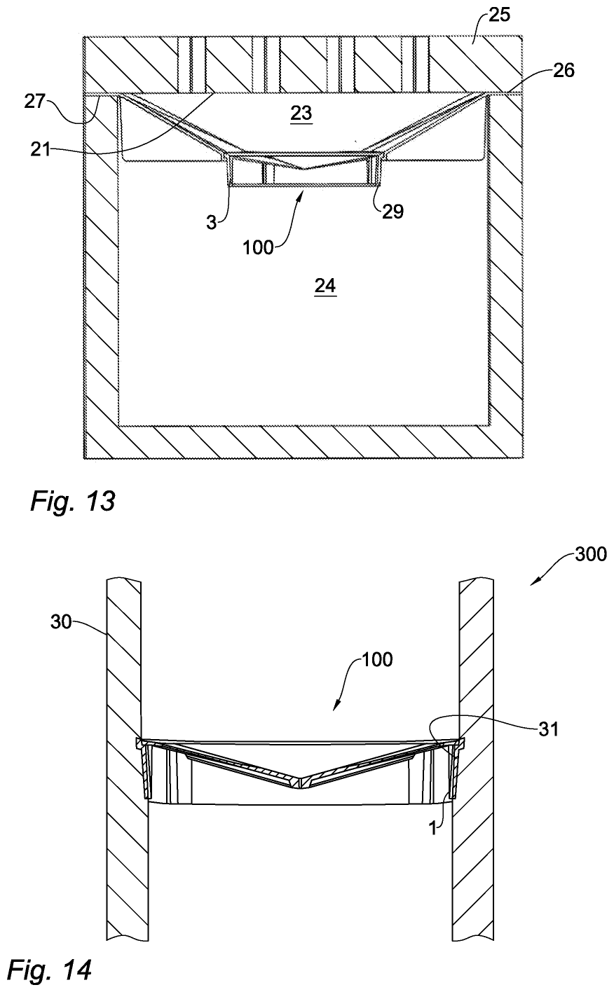

With reference to FIGS. 11 to 13, a water trap according to the present invention is generally designated 200.

The water trap 200 comprises a box-shaped tank 17 which comprises a base 18 and a plurality of side walls 19 which delimit a cavity 20 in communication with an opening 21 of the tank 17 opposite the base 18.

The water trap 200 further comprises the valve device according to 100 and a support 22 which is capable of fixing the valve device 100 to the tank 17, blocking it inside the cavity 20, in which the support 22 and the valve device 100 together subdivide the cavity 20 into two chambers 23, 24, one below the other.

A cover 25 is placed on the valve device 100 so as to close the opening 21.

The support 22 has an inverted frustoconical shape and is provided at an upper end thereof with a peripheral end piece 26 which is intended to move into abutment with an edge 27 of the tank 17 which delimits the opening 21 thereof. The support 22 terminates in a circular opening 28 which is delimited by a surface 29 which is suitable for pressing the hollow member 1 by means of the contact with the peripheral surface 3 thereof (or with an external surface of the belt 15, if present), placing and maintaining the hollow member 1 in the state for use.

With reference to FIG. 14, a pipe for discharging waste water according to the present invention is generally designated 300.

The pipe 300 comprises a tube 30 and the valve device 100 placed inside the tube 30. The tube 30 has a transverse extent less than that of the hollow member 1 of the valve device 100 when it is in the rest state so as to press the hollow member 1 by means of the contact between an internal surface 31 of the tube and the peripheral surface 3 of the hollow member 1, placing and maintaining the hollow member 1 in the state for use.

The invention thereby solves the problem set out, at the same time achieving a number of advantages. In particular, the valve device according to the invention solves the problem of aeriform fluids rising in the water traps and/or pipes for discharging waste water.

1. A valve device (100) comprising:
a hollow member (1) which comprises:
a through-hole (2) having an axis X,
an internal surface (2a) which delimits the through-hole (2),
a peripheral surface (3) which delimits the transverse extent of the hollow member (3) with respect to the axis X, and
at least one deformation zone (4, 5, 6) which is capable of being deformed so as to reduce the transverse extent of the hollow member (1) when one or more compression forces act on the peripheral surface (3), the deformation of the at least one deformation zone (4, 5, 6) moving the hollow member (1) from a rest state to a use state,
at least one closure portion (7, 8, 9) which extends radially from the hollow member (1) inside the through-hole (2) up to a respective free edge (10, 11, 12), which is substantially in contact with the internal surface (2a) of the hollow member (1) and/or with at least one free edge of another closure portion so as to occlude the through-hole (2) when the hollow member (1) is in the use state,
wherein the at least one closure portion (7, 8, 9) comprises a flexible membrane which is capable of folding when the flexible membrane is subjected to a pressure of a fluid and/or solid which moves in the through-hole (2) along the axis X, thereby defining a passage which allows the fluid and/or solid to pass through the through-hole (2).

2. The valve device according to claim 1, wherein the at least one deformation zone (4, 5, 6) is made of deformable material, or of resiliently deformable material.

3. The valve device according to claim 2, wherein the at least one deformation zone (4, 5, 6) corresponds to a recess of the hollow member (1).

4. The valve device according to claim 2, wherein the at least one deformation zone corresponds to a projection of the hollow member (1), the projection having a longitudinal extent in accordance with the axis X.

5. The valve device according to claim 1, wherein the flexible membrane of the at least one closure portion (7, 8, 9) is made of deformable material and is subjected to resilient deformation when the pressure applied to the relevant closure portion is greater than or equal to 50 Pa.

6. The valve device according to claim 2, wherein the deformable material has an elasticity modulus between 1 Mpa and 5 Mpa according to the standard ASTM D412 DIE C.

7. The valve device according to claim 1, wherein the free edge (10, 11, 12) of the at least one closure portion (7, 8, 9) comprises an edging (10a, 11b, 12c) which extends substantially along the axis X when the hollow member (1) is in the state for use.

8. The valve device according to claim 1, wherein the valve device (100) comprises a plurality of closure portions (7, 8, 9), each closure portion (7, 8, 9) being in the form of a circular sector and extending between a deformation zone (4, 5, 6) and a subsequent deformation zone.

9. The valve device according to claim 1, wherein the hollow member (1) and the at least one closure portion (7, 8, 9) are formed from a single piece of deformable material, preferably resiliently deformable material, more preferably silicone material.

10. The valve device according to claim 1, wherein the hollow member (1) extends along the axis X from a first end (13) to a second end (14), the at least one closure portion (7) extending from the first end (13) towards the second end (14) when the respective free edge (10) is substantially in contact with the internal surface (2a) of the hollow member (1) and/or with at least one free edge of another closure portion.

11. The valve device according to claim 1, comprising a belt (15) which has a transverse extent less than that of the hollow member (1) when the belt (15) is in the rest state so as to press the hollow member (1) by means of the contact between an internal face (16) of the belt (15) and the peripheral surface (3) of the hollow member (1) when the hollow member (1) is inserted in the belt (15), placing and maintaining the hollow member (1) in the state for use.

12. A water trap (200) comprising:
a box-shaped tank (17) which comprises a base (18) and a plurality of side walls (19) which delimit a cavity (20) in communication with an opening (21) of the tank (17) opposite the base (18),
a valve device (100) according to claim 1,
a support (22) which is configured to fix the valve device (100) to the tank (17) by blocking the valve device (100) inside the cavity (20), wherein the support (22) and the valve device (100) together subdivide the cavity (20) into two chambers (23, 24), one under the other, and
a cover (25) which is positioned above the valve device (100) for closing the opening (21).

13. A pipe (300) for discharging waste water comprising a tube (30) and a valve device (100) according to claim 1, wherein the valve device (100) is positioned inside the tube (30) and the tube (30) has a transverse extent less than that of the hollow member (1) of the valve device (100) when the hollow member (1) is in the rest state so as to press the hollow member (1) by means of the contact between an internal surface (31) of the tube (30) and the peripheral surface (3) of the hollow member (1), placing and maintaining the hollow member (1) in the use state.
